(19) United States
(12) Patent Application Publication
(10) Pub. No.: US 2015/0053286 A1
(43) Pub. Date: Feb. 26, 2015

(54) SUCTION STRUCTURE HAVING PLURALITY OF SUCTION ASSEMBLIES

(71) Applicants: SHENZHEN FUTAIHONG PRECISION INDUSTRY CO., LTD., Shenzhen (CN); FIH (Hong Kong) Limited, Kowloon (HK)

(72) Inventors: XING-HUA CHEN, Shenzhen (CN); JIE GAO, Shenzhen (CN); JIAN-FENG ZHANG, Shenzhen (CN)

(21) Appl. No.: 14/465,118

(22) Filed: Aug. 21, 2014

(30) Foreign Application Priority Data
Aug. 22, 2013 (CN) 2013103672330

(51) Int. Cl. B25J 19/00

(52) U.S. Cl. CPC B25J 19/0025
USPC 137/565.23

(57) ABSTRACT

A suction structure includes a connection member and at least one suction assembly coupled to the connection member. The at least one suction assembly includes a base, a suction member, at least one first buffering member, at least one second buffering member, and at least one pushing member. The at least one suction assembly is assembled on the base. The at least one first buffering member is at least partially housed in the base. The at least one second buffering member forms a sleeve around at least a portion of the base. The at least one pushing member cooperates with the base and has a first end coupled to the at least one first buffering member and a second end at least partially exposed from with the suction member.

### FIELD

The disclosure generally relates to a suction structure.

### BACKGROUND

In industrial production, when products need to be transmitted, force can be generated by a suction member, and can be applied to the products via a pushing member.

### BRIEF DESCRIPTION OF THE DRAWINGS

Implementations of the present technology will now be described, by way of example only, with reference to the attached figures, wherein:

FIG. 1 is an exploded, isometric view of an embodiment of a suction structure.

FIG. 2 is an exploded, isometric view of a first suction assembly of the suction structure of FIG. 1.

FIG. 3 is a partially cross-sectional view of a base of the first suction assembly of FIG. 2.

FIG. 4 is an exploded, isometric view of a second suction assembly of the suction structure of FIG. 1.

FIG. 5 is an exploded, isometric view of a third suction assembly of the suction structure of FIG. 1.

FIG. 6 is an assembled view of the suction structure of FIG. 1.

FIG. 7 is a partially cross-sectional view of the suction structure of FIG. 6.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

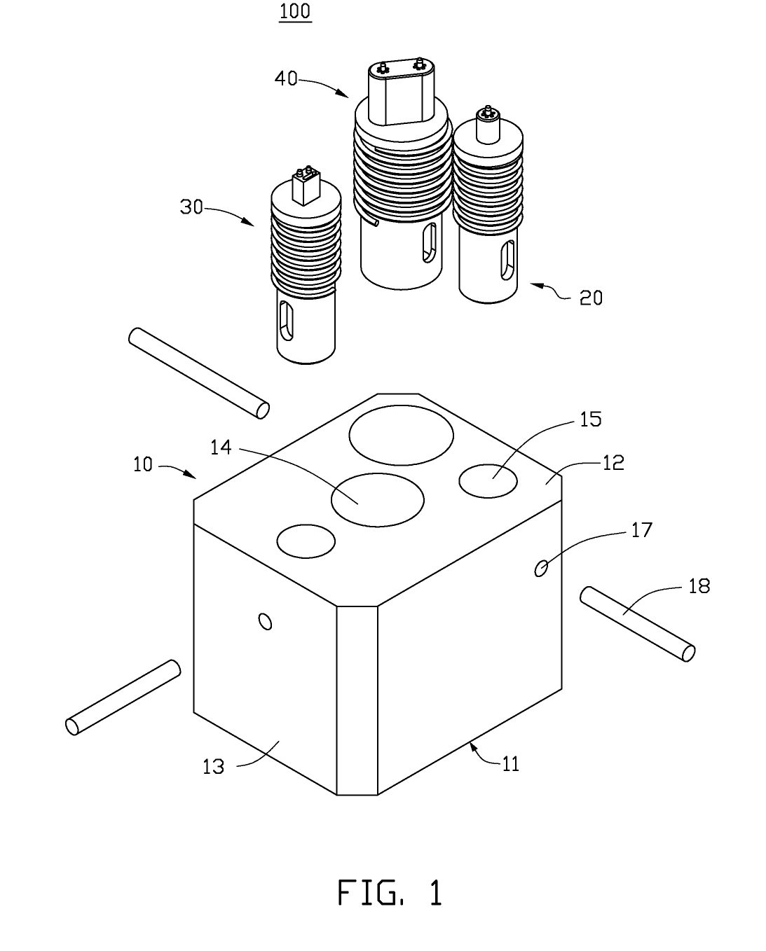

FIG. 1 illustrates a suction structure 100, which can be mounted to a manipulator or a cylinder and is configured to suck and move products under a control of the manipulator or the cylinder. The suction structure 100 includes a connection member 10 and at least one suction assembly mounted on the connection member 10. In this embodiment, there are three suction assemblies, which are separately labeled as 20, 30, 40.

The connection member 10 includes a first surface 11, a second surface 12 opposite to the first surface 11, and a peripheral surface 13 perpendicularly connected to the first surface 11 and the second surface 13. A mounting groove 14 and at least one receiving cavity 15 corresponding to the at least one suction assembly are defined on the connection member 10. The mounting groove 14 is opened through the first surface 11 and the second surface 12 and is configured to assemble the connection member 10 to the manipulator or the cylinder. In this embodiment, there are three receiving cavities 15. The receiving cavities 15 are defined in the second surface 12 and positioned around the mounting groove 14. The three receiving cavities 15 are configured to receive the corresponding suction assemblies 20, 30, 40. The peripheral surface 13 defines at least one pin hole 17 corresponding to the at least one receiving cavity 15. In this embodiment, there are three pin holes 17. Each pin hole 17 is coupled to the corresponding receiving cavity 15 by a channel and is configured to insert a pin 18 into the corresponding receiving cavity 15.

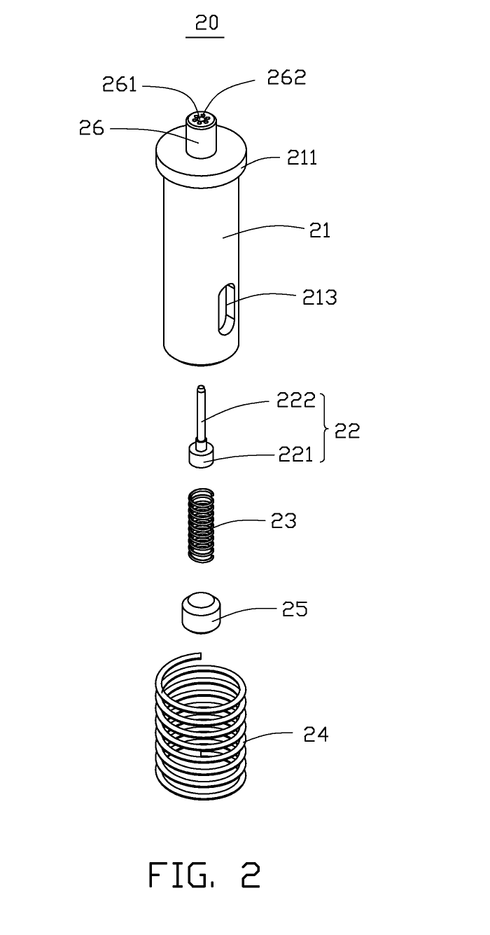

FIG. 2 shows that the suction assembly 20 is assembled in one of the receiving cavities 15 and includes a base 21, a pushing member 22, a first buffering member 23, a second buffering member 24, and a fixing block 25. The base 21 is substantially a hollow cylinder with an open end and a closed end. A flange 211 protrudes on the closed end of the base 21. The base 21 defines two opposite limitation holes 213 which are located adjacent to the open end of the base 21. The pin 18 can be inserted into the two limitation holes 213 and the corresponding pin hole 17 to prevent the base 21 from moving. The pushing member 22 includes a pushing block 221 and a pushing pin 222 mounted thereon. In this embodiment, the first buffering member 23 is a spiral spring. A first end of the first buffering member 23 is fixed to the fixing block 25. A second end of the first buffering member 23 is fixed to a side of the pushing block 221 of the pushing member 22 away from the pushing pin 222. The second buffering member 24 is sleeved on the base 21 with a first end being fixed to the flange 211 and a second end being fixed to the second surface 12 of the connection member 10.

The closed end of the base 21 further forms a suction member 26. The suction member 26 is substantially a hollow cylinder and is positioned in a side of the flange 211 away from the base 21. The suction member 26 defines a needle hole 261 and a group of air holes 262 around the needle hole 261. The needle hole 261 is configured to receive the pushing pin 222 and the first buffering member 23 can drive the pushing pin 222 to be exposed from the needle hole 261 of the suction member 26.

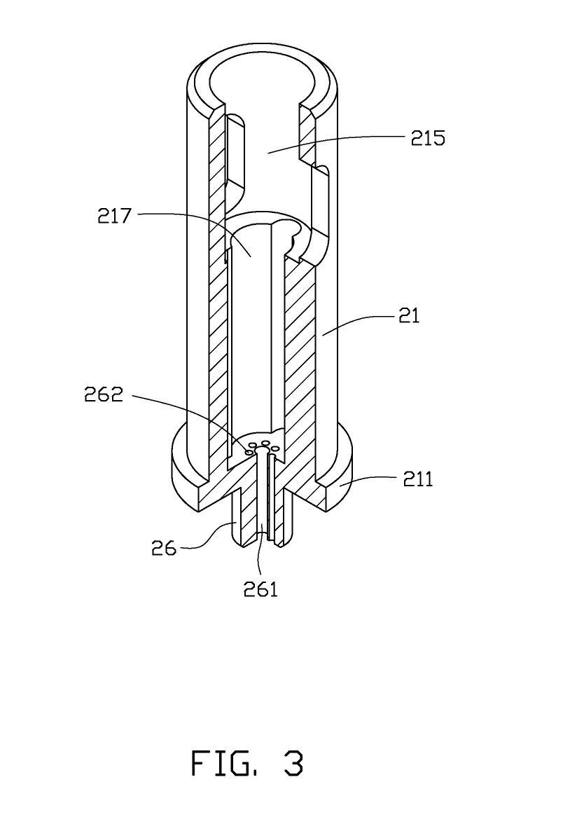

FIG. 3 illustrates that the base 21 further defines a receiving hole 215 and a connecting hole 217 in an axial direction of the base 21. In this embodiment, a diameter of the connecting hole 217 is less than a diameter of the receiving hole 215. All of the needle hole 261 and the air holes 262 are communicated with the receiving hole 215 and the connecting hole 217 by channels.

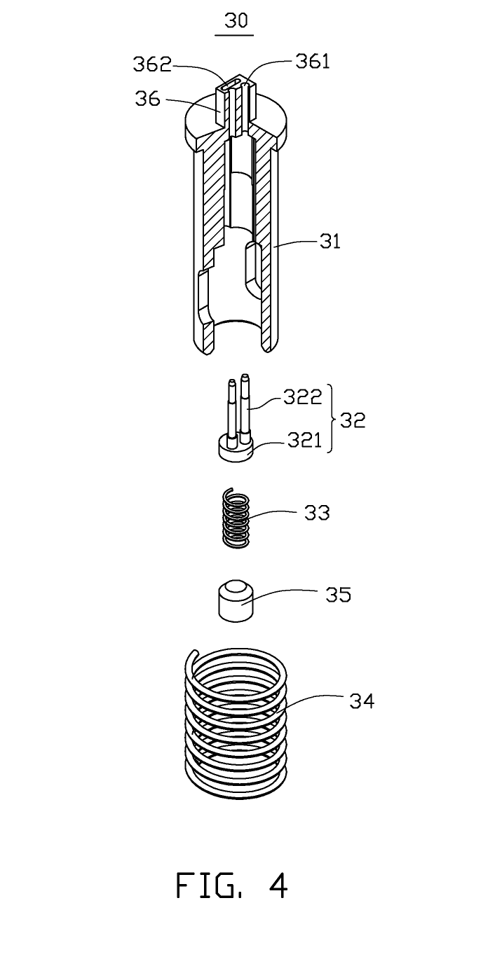

FIG. 4 shows the suction assembly 30 includes a base 31, a pushing member 32, a first buffering member 33, a second buffering member 34, and a fixing block 35. The base 31 is substantially a hollow cylinder with an open end and a closed end. The closed end of the base 31 forms a suction member 36. In this embodiment, the suction assembly 30 differs from the suction assembly 20 only in that the suction member 36 defines two needle holes 361 and an air hole 362, and the pushing member 32 includes a pushing block 321 and two pushing pins 222 mounted thereon. The air hole 362 is positioned in a side of the two needle holes 361. Each needle hole 361 is configured to receive a corresponding pushing pin 322 and the first buffering member 33 can drive the two pushing pins 322 to be exposed from the corresponding needle hole 361 of the suction member 36.

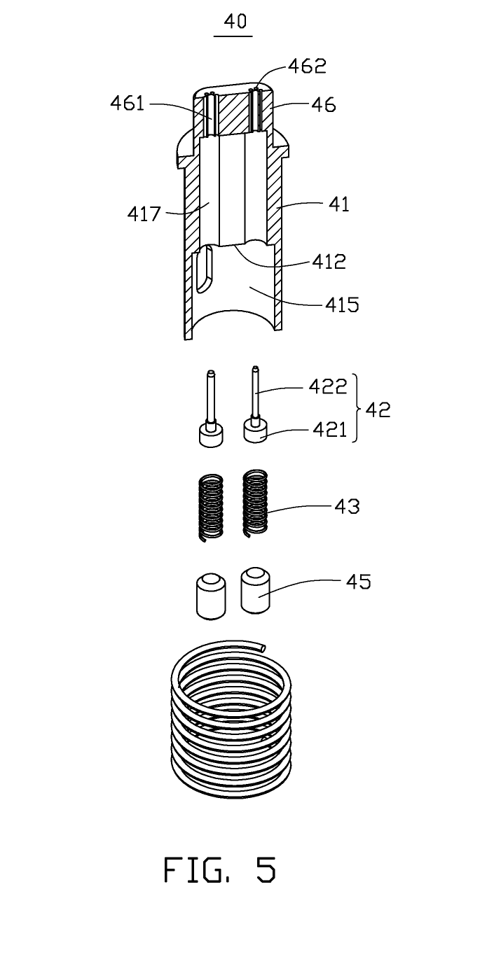

FIG. 5 illustrates the suction assembly 40 includes a base 41. The base 41 is substantially a hollow cylinder with an open end and a closed end. The closed end of the base 41 forms a suction member 46. In this embodiment, the suction assembly 40 differs from the suction assembly 20 only in that the suction assembly 40 includes two pushing members 42, two first buffering members 43, and two fixing blocks 45, and the suction member 46 defines two needle holes 461, two groups of air holes 462, and two connecting holes 417. Each pushing member 42 includes a pushing block 421 and a pushing pins 422 mounted thereon. Each pushing pin 422 corresponds to a corresponding needle hole 461. A first end of each first buffering member 43 is fixed to a corresponding fixing block 45. A second end of each first buffering member 43 is fixed to a side of the corresponding pushing block 421 of the pushing member 42. Each group of air holes 462 are around a corresponding needle hole 461. Each needle hole 461 is configured to receive a corresponding pushing pin 422 and the first buffering member 43 can drive the corresponding pushing pin 422 to be exposed from the corresponding needle hole 461 of the suction member 46.

In this embodiment, the two connecting holes 417 are defined in a bottom surface 412 of the receiving hole 415, extend towards the closed end of the base 41, and are coupled to the corresponding needle hole 461 by a channel. The two connecting holes 417 are also communicated with the receiving hole 415. That is, the needle holes 461, the air holes 462, and the connecting holes 417 are all communicated with the receiving holes 415 by channels.

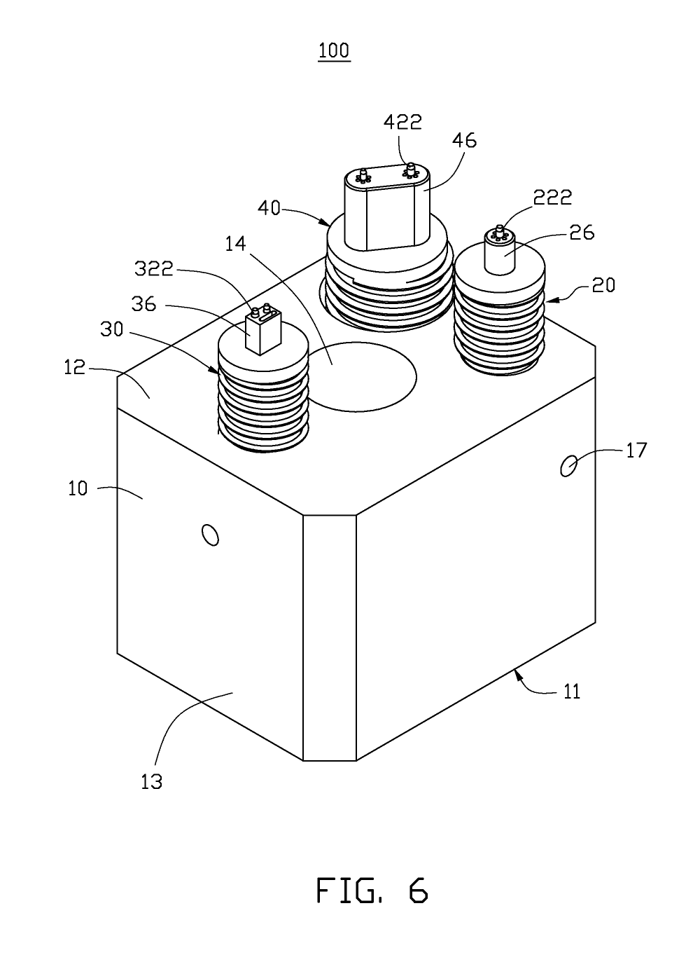

FIG. 6 illustrates that the suction assemblies 20, 30, 40 are assembled on the connection member 10 to suck different products. For example, when the suction assembly 20 is assembled to the connection member 10, the base 21 is accommodated in one of the receiving cavities 15. The pin 18 is inserted into the pin hole 17 and the two limitation holes 213 to fix the base 21 into the receiving cavity 15. Then, a part of the receiving cavity 15, the receiving hole 215, and the connecting hole 217 cooperatively define an air cavity to accommodate air. Lubricating oil can be smeared between the base 21 and the receiving cavity 15 to keep a smooth sliding between the base 21 and the receiving cavity 15 and seal the air cavity. A first end of the second buffering member 24 is fixed to the flange 211 and a second end of the second buffering member 24 is fixed to the bottom surface 12 of the connection member 10. The suction assembly 30 and the suction assembly 40 are assembled to the connection member 10 with similar means like the suction assembly 20.

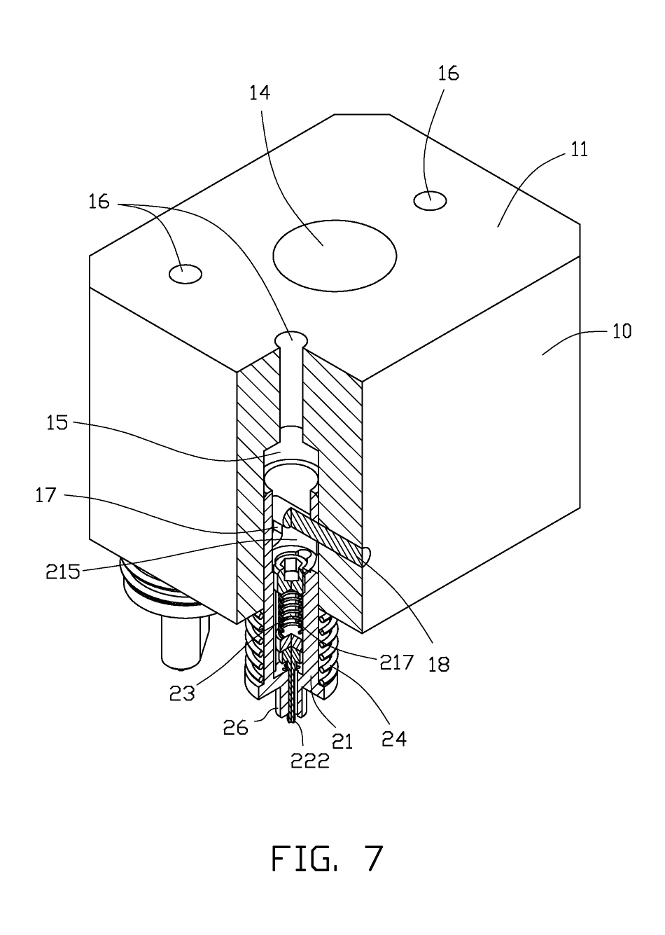

FIG. 7 shows that the first surface 11 further defines at least one air hole 16 coupled to a corresponding receiving cavity 15 by a channel. In this embodiment, the number of the at least one air hole 16 is three and each air hole 16 corresponds to a receiving cavity 15. In use of the suction structure 100, the air holes 16 can be connected to air tubes to allow the air cavity to be filled with air and the connection member 10 is driven above the products by the manipulator or the cylinder to make the suction member 26 aims at the products. Then, the suction assemblies 20, 30, 40 are driven downward to allow the pushing pins 222, 322, 422 of the pushing members 22, 32, 42 to be inserted into a corresponding location hole of the products to suck the products.

When the products are sucked, a force is generated among the pushing members 22, 32, 42, the suction members 26, 36, 46, and the products, and the pushing members 22, 32, 42 will be impacted by the force from the products. Then, the first buffering members 23, 33, 43 and the second buffering members 24, 34, 44 will be retracted by the force which can effectively reduce the force among the products, the pushing pins 222, 322, 422 of the pushing members 22, 32, 42, and the suction members 26, 36, 46, thereby protecting the products, the pushing pins 222, 322, 422 of the pushing members 22, 32, 42, and the suction members 26, 36, 46 from damage.

In other embodiments, the second buffering member 24, 34, 44 can be replaced by a plurality of springs or elastic blocks.

In other embodiment, the cavities 15 can be configured to receive three suction assemblies 20, three suction assemblies 30, three suction assemblies 40, or other combination of suction assemblies 20, 30, 40.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A suction structure comprising:
a connection member;
at least one suction assembly coupled to the connection member, the at least one suction assembly comprising:
a base;
a suction member coupled to the base;
at least one first buffering member at least partially housed in the base;
at least one second buffering member forming a sleeve around at least a portion of the base; and
at least one pushing member cooperating with the base and having a first end coupled to the at least one first buffering member and a second end at least partially exposed from within the suction member.

2. The suction structure of claim 1, wherein the at least one suction assembly further comprises at least one fixing block corresponding to the at least one first buffering member, a first end of the at least one first buffering member is fixed to the corresponding fixing block and a second end of the at least one first buffering member is fixed to the corresponding pushing member.

3. The suction structure of claim 2, wherein the base is a hollow cylinder with an open end and a closed end, a flange protrudes on the closed end of the base, the suction member is positioned in a side of the flange away from the base, and the at least one second buffering member is fixed between the flange and the connection member.

4. The suction structure of claim 3, wherein the base defines two opposite limitation holes which are located adjacent to the open end of the base, the connection member defines at least one receiving cavity and at least one pin hole coupled to the corresponding receiving cavity, the base is accommodated in the corresponding receiving cavity and a pin is inserted into the corresponding pin hole and the two limitation holes.

5. The suction structure of claim 4, wherein the number of the at least one receiving cavity is three, the connection member defines a mounting groove and three air holes, and each air hole corresponds to a corresponding receiving cavity and is coupled to the corresponding receiving cavity by a channel.

6. The suction structure of claim 2, wherein the base defines a receiving hole and a connecting hole in an axial direction of the base; the suction member forms at least one needle hole and at least a group of air holes around the at least one needle hole, the needle hole and the air holes are all communicated with the receiving hole and the connecting hole.

7. The suction structure of claim 6, wherein the at least one pushing member comprises a pushing block and at least one pushing pin mounted thereon, the second end of the at least one first buffering member is fixed to the pushing block away from the at least one pushing pin, and the pushing pin is exposed from the corresponding needle hole.

8. The suction member of claim 7, wherein the suction member defines a needle hole and a group of air holes around the needle hole, the number of the at least one pushing member is one, and the number of the at least one first buffering member is one; the pushing member comprises a pushing block and a pushing pins mounted thereon, the first buffering member is fixed to the pushing block, and the pushing pin is exposed from the needle hole.

9. The suction member of claim 7, wherein the suction member defines two needle holes and one air hole, the air hole is positioned adjacent to the two needle holes, the number of the at least one pushing member is one, and the number of the at least one first buffering member is one; the pushing member comprises a pushing block and two pushing pins mounted thereon, the first buffering member is fixed to the pushing block, each pushing pin is exposed from the corresponding needle hole.

10. The suction structure of claim 7, wherein the suction member defines two needle holes and two groups of air holes, the two groups of air holes are around the corresponding needle hole, the number of the at least one pushing member is two, the number of the at least one first buffering member is two, and the number of the at least one fixing member is two; each first buffering member is a spiral spring, each pushing member comprises a pushing block and a pushing pin, a first end of each first buffering member is fixed to the corresponding fixing block, a second end of each first buffering member is fixed to the corresponding pushing block away from the pushing pin, and each pushing pin is exposed from the corresponding needle hole.

11. A suction structure comprising:
a connection member; and
a suction assembly, the suction assembly comprising:
a base assembled in the connection member;
a suction member mounted on the base;
at least one first buffering member at least partially housed in the base;
at least one second buffering member forming a sleeve around at least a portion of the base; and
at least one pushing member cooperating with the base and having a first end coupled to the at least one first buffering member and a second end at least partially exposed from within the suction member.
wherein when the pushing member and the base are impacted by force, the at least one first buffering member and the at least one second buffering member reduce the force on the base and the at least one pushing member.

12. The suction structure of claim 11, wherein the at least one suction assembly further comprises at least one fixing block corresponding to the at least one first buffering member, a first end of the at least one first buffering member is fixed to the corresponding fixing block and a second end of the at least one first buffering member is fixed to the corresponding pushing member.

13. The suction structure of claim 12, wherein the base is a hollow cylinder with an open end and a closed end, a flange protrudes on the closed end of the base, the suction member is positioned in a side of the flange away from the base, and the at least one second buffering member is fixed between the flange and the connection member.

14. The suction structure of claim 13, wherein the base defines two opposite limitation holes which are located adjacent to the open end of the base, the connection member defines at least one receiving cavity and at least one pin hole coupled to the corresponding receiving cavity, the base is accommodated in the corresponding receiving cavity and a pin is inserted into the corresponding pin hole and the two limitation holes.

15. The suction structure of claim 14, wherein the number of the at least one receiving cavity is three, the connection member defines a mounting groove and three air holes, and each air hole corresponds to a corresponding receiving cavity and is coupled to the corresponding receiving cavity by a channel.

16. The suction structure of claim 12, wherein the base defines a receiving hole and a connecting hole in an axial direction of the base; the suction member forms at least one needle hole and at least a group of air holes around the at least one needle hole, the needle hole and the air holes are all communicated with the receiving hole and the connecting hole.

17. The suction structure of claim 16, wherein the at least one pushing member comprises a pushing block and at least one pushing pin mounted thereon, the second end of the at least one first buffering member is fixed to the pushing block away from the at least one pushing pin, and the pushing pin is exposed from the corresponding needle hole.

18. The suction member of claim 17, wherein the suction member defines a needle hole and a group of air holes around the needle hole, the number of the at least one pushing member is one, and the number of the at least one first buffering member is one; the pushing member comprises a pushing block and a pushing pins mounted thereon, the first buffering member is fixed to the pushing block, and the pushing pin is exposed from the needle hole.

19. The suction member of claim 17, wherein the suction member defines two needle holes and one air hole, the air hole is positioned adjacent to the two needle holes, the number of the at least one pushing member is one, and the number of the at least one first buffering member is one; the pushing member comprises a pushing block and two pushing pins mounted thereon, the first buffering member is fixed to the pushing block, each pushing pin is exposed from the corresponding needle hole.

20. The suction structure of claim 17, wherein the suction member defines two needle holes and two groups of air holes, the two groups of air holes are around the corresponding needle hole, the number of the at least one pushing member is two, the number of the at least one first buffering member is two, and the number of the at least one fixing member is two; each first buffering member is a spiral spring, each pushing member comprises a pushing block and a pushing pin, a first end of each first buffering member is fixed to the corresponding fixing block, a second end of each first buffering member is fixed to the corresponding pushing block away from the pushing pin, and each pushing pin is exposed from the corresponding needle hole.
